(19) United States
(12) Patent Application Publication
(10) Pub. No.: US 2007/0019204 A1
(43) Pub. Date: Jan. 25, 2007

(54) Spectrometer based multiband optical monitoring of thin films

(76) Inventor: Peter B. Thomas, Palm Harbor, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/188,443

(22) Filed: Jul. 25, 2005

(51) Int. Cl. G01B 11/02

(52) U.S. Cl. 356/503

(57) ABSTRACT

A spectrometer based optical monitoring system is provided with a fiber optics transmission/reflection probe measuring in-situ data of a fixed and/or a rotational monitor. Single or multiple spectral bands are measured instantaneously by the spectrometer to monitor the thickness of each material layer as it is being applied. The single or multiple spectral band system will measure each layer and the total layers and compare the spectral bands of the two to the theoretical spectral designs over the measured region.

### FIELD OF INVENTION

This invention relates to the field of thin film deposition, and more specifically to the measurement of in-situ optical monitoring using a spectrometer/spectrophotometer.

### BACKGROUND INFORMATION

The evolution of the laser, telecommunication, and semiconductor industry has created demand for better performing optical thin films. Devices that once allowed a higher margin of error are now requiring very specific spectral performances. There have been difficulties applying the theoretical design modules to actual results because of inaccurate film thickness measurements. Deposition rate control, crystal monitoring, and optical monitoring have been the standard methods used in the past, but new methods need to be developed to meet these stringent requirements.

Optical thin films manipulate light by creating boundary layers that reflect and transmit light. Differences between indices (index of refraction) of the layers, the layer thicknesses, and the number of layers create phase differentials that affect how the light propagates. Advanced mathematical formulas have been used that take variables and predict the results. Today, there are many software packages available that have incorporated the mathematics to assist in thin film design.

Standard quarter waves and half waves of the design wavelength were first used. This was the most practical and accurate method of applying thin films. Optical monitors have used broadband light sources and wavelength specific filters to achieve monochromatic monitoring. The single wavelength light source is then transmitted into the chamber, reflected/transmitted off the part, transmits out of the chamber, and measured. This only allows for a film to be monitored at one wavelength. The monitor or chip needs to be changed every six layers to maintain a measurable signal. This setup is illustrated in FIG. 8.

Deposition rates and evaporative energies can be used to control thicknesses of the films. Deposition rate monitoring uses these variables to determine film thickness.

Crystal monitoring measures the change of frequency of a monitor chip. The frequency will change as more material is deposited onto the crystal. The controller measures the change of frequency and determines the physical thickness of the film.

Optical monitoring of monochromatic partial waves is one of the most accurate methods of measuring the growth of thin films. Theoretical designs are plotted to meet the measured data. Standard quarter waves, half waves, and partial waves are computed once the design parameters are entered into the software.

Applying the thin film (Physical Vapor Deposition/Chemical Vapor Deposition) is controlled in a vacuum environment.

There are various methods used to apply these films. Three of the most common are resistance, electron beam deposition, and ion beam sputtering.

Resistive evaporation uses a thermal source to heat the coating material. The material starts to evaporate once it reaches the melting point. This is a cost effective way to apply films. Numerous thermal sources can be used to melt different material during process.

Electrons beam deposition deposits the coating materials using a high voltage beam. The process is controlled by steering the beam into the material and the energies used to evaporate.

Ion beam sputtering creates plasma ions that bombards the coating material (target) and sputters the deposition material onto the substrates.

Optical monitor based measuring systems have typically used different light sources and optical filters to achieve the monochromatic wavelength. The beam enters the vacuum chamber through a window, reflects/transmits through a fixed optic (monitor chip), and then exits through another window. The beam is collected and then the intensity is measured. The deposition materials will change the reflection/transmission as the coating is applied. This change in reflection/transmission will create the waveform used to monitor at one wavelength.

Distribution is another problem of the fixed monitor chip. The monitor substrate inside the vacuum chamber does not represent the actual film that is being applied. The work usually rotates around the monitor. Therefore, more material is deposited on the monitor and less is deposited on the work. The thicknesses of the monitor and work are different. The term, “monitor to work ratio” is used to figure out the difference between the measured value of the chip and the actual film on the work.

### SUMMARY OF THE INVENTION

This invention provides apparatus and methods for making instantaneous and delayed in-situ measurements of partial waves at specific wavelengths and more importantly, measurements of multiple scanning wavelengths using a spectrometer/spectrophotometer.

More particularly, the invention is a method of measuring thin film thicknesses on a substrate, the method comprising the use of a spectrometer or a spectrophotometer based optical monitoring system. The spectrometer or spectrophotometer measures film thickness deposited on the substrate during and after a deposition process.

The spectrometer or spectrophotometer is capable of measuring in-situ reflectance or transmission of film growth or a combination of the reflectance and transmission of film growth during the deposition process and after a final layer is complete. The spectrometer or spectrophotometer also makes instantaneous and/or delayed measurements of partial waves at a specific wavelength and/or of multiple scanning wavelengths.

The optical monitoring system comprises either a spectrometer or a spectrophotometer, either a fiber optics transmission probe, a collection probe or a combination of such transmission and collection probes, a broadband light source, and means for collecting and processing data related to the deposition of material on a substrate during a deposition and after a deposition process. Such means includes computer hardware and software where one skilled in the art of programming, given the parameters to be monitored, can write the code for the software.

Thin films applied to the substrate during the deposition process are measured. The spectrometer or the spectrophotometer measures transmission of film growth on the substrate during the deposition process, or reflectance of film growth on the substrate during the deposition process, or a combination of the transmission and reflectance of film growth on the substrate during the deposition process. In addition, the system is adapted to measure thin films after the deposition process is complete.

The system is adapted to measure in-situ data of a fixed monitor substrate, a rotational monitor substrate, a process substrate or any combination of a fixed monitor substrate, a rotational monitor substrate or a process substrate. The system is further adapted to measure single or multiple spectral bands to monitor the thickness of each material layer as it is being applied. The single or multiple spectral bands measure the reflectance and/or transmission of each layer of film deposited and the total layers of deposited films.

The system includes processing means designed in the software and data collection portions of the invention for comparing the spectral bands of the reflectance and/or transmission of each layer of film deposited to the theoretical spectral designs over the measured region.

In another embodiment, the spectrometer or spectrophotometer single or multiple spectral scanning band based thin film optical monitoring system comprises a fiber optic probe constructed for a vacuum environment that includes multiple fibers that transmit and collect optical properties of a fixed position monitor substrate, a process substrate or a combination of said fixed position monitor substrate and said process substrate, which is adapted for thin film monitors and measuring, and processing means for collecting and analyzing the optical properties related to a deposition process. The processing means includes means for measuring an instantaneous single wavelength transmission, a reflection or a combination of the transmission and reflection of a fixed position monitor substrate or process substrate.

In addition, the processing means includes means for measuring a single wavelength transmission, a reflection or a combination of the transmission and reflection measurement of an actual fixed position monitor substrate or process substrate, wherein the process substrate is an actual production part being coated.

The system is adapted to measure in-situ reflection or transmission or a combination of said reflection and transmission of film growth during the deposition process, and is adapted to measure in-situ reflection or transmission or a combination of the in-situ reflection and transmission measurements during film growth.

The processing means further includes means for measuring multiple wavelength transmission, reflection or a combination of said transmission and reflection measurements of the process substrate. The processing means also is capable of measuring multiple wavelength transmission, reflection or a combination of the transmission and reflection measurements of the process substrate instantaneously. The system is adapted to measure the in-situ reflection or transmission or combination of the reflection and transmission of film growth during the deposition process instantaneously. It measures a deposition controlled film growth that compares a theoretical layer design to a measured layer thickness at the fixed position monitor substrate. Further, it is capable of measuring a deposition controlled film growth that compares a theoretical layer design to a measured layer thickness at the process substrate.

### BRIEF DESCRIPTION OF THE DRAWINGS

FIG. 1 a is a conceptual depiction of a fiber optic probe in respect to monitor substrate;

FIG. 1b is a conceptual depiction of a fiber optic probe in respect to process substrate;

FIG. 2 is a conceptual depiction of a spectrometer;

FIG. 3 is a conceptual depiction of a standard vacuum deposition chamber;

FIG. 4 is a conceptual depiction of a standard electron beam system;

FIG. 5 is a conceptual depiction of a standard ion beam sputtering system;

FIG. 6 is a conceptual depiction of a rotating planetary system;

FIG. 7 is a conceptual depiction of a fiber optic transmission/collecting probe;

FIG. 8 is a conceptual depiction of an optical monitor system;

FIG. 9 is an example of a thin film partial design using a monochromatic light source;

FIG. 10 is a table presenting an example of an optical design using a H L 2H L H recipe;

FIG. 11 illustrates the first completed layer of a five layer design measured in reflection;

FIG. 12 illustrates the second completed layer of a five layer design measured in reflection;

FIG. 13 illustrates the third completed layer of a five layer design measured in reflection;

FIG. 14 illustrates the fourth completed layer of a five layer design measured in reflection;

FIG. 15 illustrates the fifth completed layer of a five layer design measured in reflection; and

FIG. 16 is a flow chart of the steps of the multiple band optical monitor system.

### DETAILED DESCRIPTION OF THE INVENTION

This invention includes the use of a spectrometer/spectrophotometer to measure film thicknesses during and after the process and the specific use of measuring in-situ reflectance and/or transmission of film growth during deposition and after the final layer is complete.

As referred to herein, the term “spectrometer” is to be considered synonymous with the term “spectrophotometer.”

The terms measure, measuring, and measurements are all related to the collection of the transmission, reflection, and transmission and reflection of a substrate and film/films through the probe and into the spectrometer.

Spectral response has a direct correlation to film thickness, film index, deposition rates, and other film properties. The measured spectral response can be reversed engineered to provide further information about film

This invention includes, in specific, the use of a spectrometer/spectrophotometer to measure film thicknesses during and after the process and the specific use of measuring in-situ reflectance and/or transmission of film growth during deposition and after the final layer is complete.

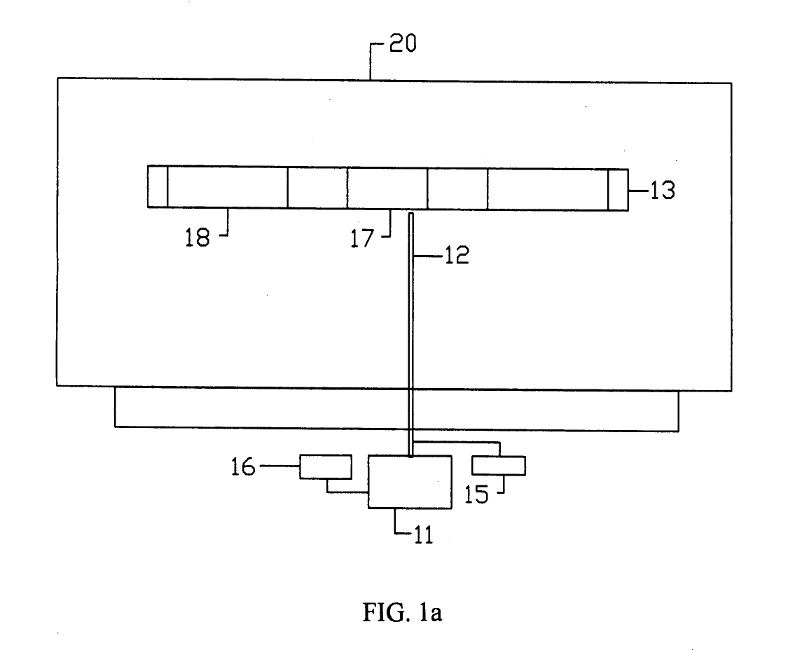

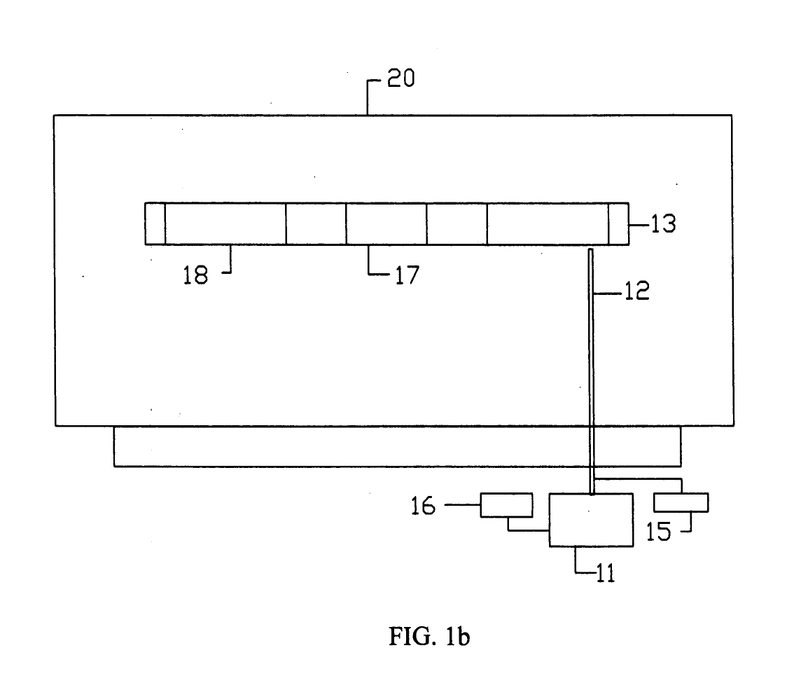

Conceptual and theoretical development had lead to a real discovery of the present invention. FIG. 1 a depicts an example of an existing functional optical monitoring comprising of a spectrometer 11, fiber optic transmission and collection probe 12, broadband light source 15, computer interface 16, and an example of the actual vacuum based process system 20. The monitor substrate 17 is an example of the fixed position transmission and/or reflection substrate. The monitor substrate 17 is a separate part of the planetary system 13. The fiber optic 12 transmission and collection probe, the planetary 13, the monitor substrate 17, and process substrate 18 are all under vacuum during operation of the present invention.

FIG. 1b depicts an example of a existing functional optical monitoring comprising of a spectrometer 11, fiber optic transmission and collection probe 12, broadband light source 15, computer interface 16, and an example of the actual vacuum based process system 20. The process substrate 18 is an example of the rotating transmission and/or reflection substrate. The process substrate 18 is a part of the planetary system 13. Those skilled in the art would understand the importance of being able to monitor any parts of the process substrate, even with a greater importance of being able to measure a finished product in the vacuum chamber 20, while the process substrates are under vacuum and at process temperatures. The fiber optic 12 transmission and collection probe, the planetary 13, the monitor substrate 17, and process substrate 18 are all under vacuum during operation of the present invention.

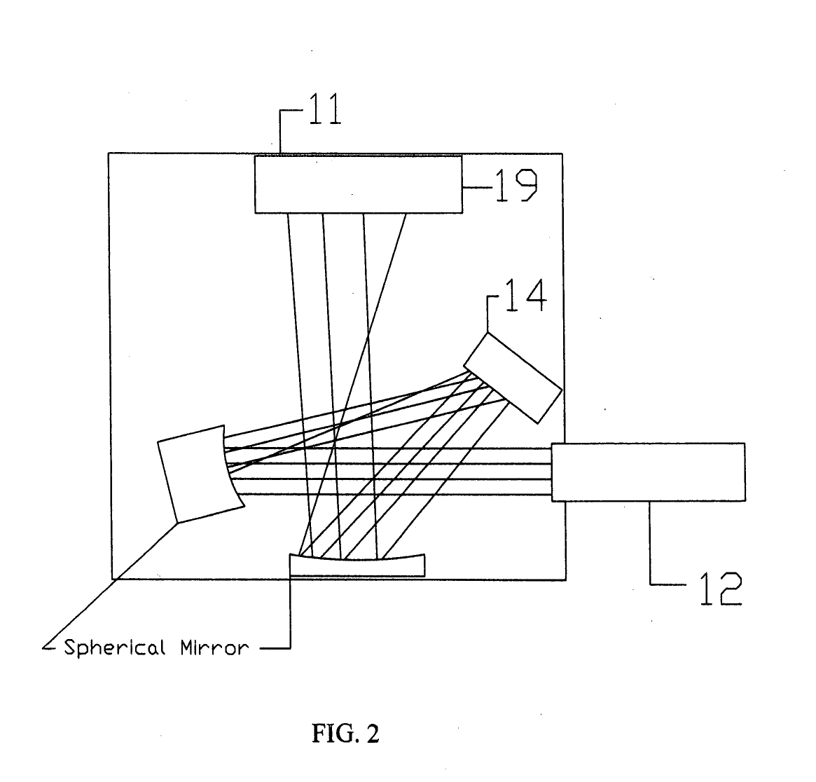

FIG. 2 is an example of a modem spectrometer. The use of the spectrometer 11 is one of the primary embodiments of the present invention. The fiber 12 transmits and collects the light as a whole. This means every wavelength that the spectrometer is capable of measuring can simultaneously process the light energy. This is possible because the diffraction grating 14 separates the light waves simultaneously and the detectors 19 measures the energies from the diffraction grating 14 and converts the light energies into digital or analog signals.

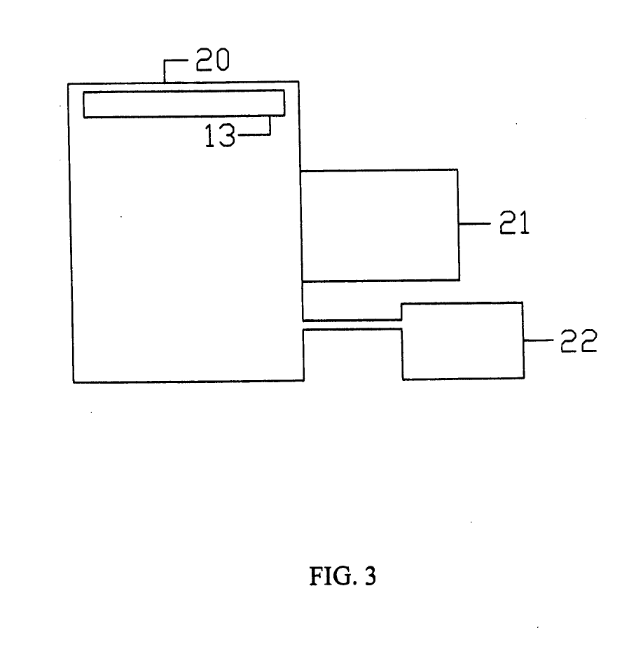

FIG. 3 is a conceptual example of a vacuum chamber 20 consisting of some of the parts that allow for a vacuum environment. Vacuum systems usually consist of 21 roughing pump 22 and a high vacuum pump 21. The planetary system is within the vacuum chamber 20.

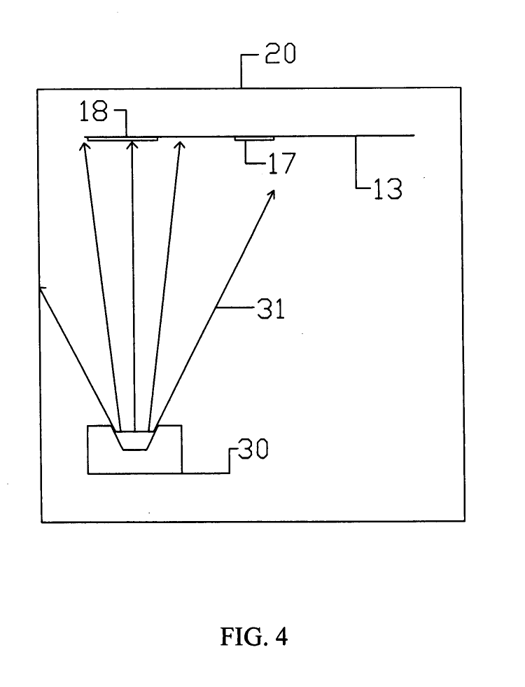

FIG. 4 is an example of a common thin film deposition process using an electron beam gun 30 depicted in this example. The material being deposited 31 is measuring the optical and physical properties of the film using the present invention. The planetary 13 is the rotation device for the process substrate 18 and/or the monitor substrate 17 is located in a fixed position with the planetary 13. This process using an electron gun requires a vacuum environment within a vacuum chamber 20.

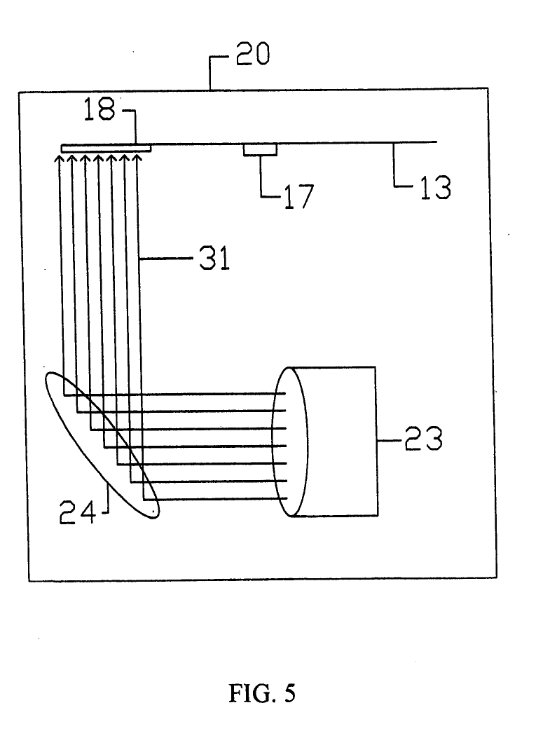

FIG. 5 is another example of a common thin film deposition process using an ion beam gun 23 is depicted in this example. The material being deposited 31 from a material target 24 is measuring the optical and physical properties of the film using the present invention. The planetary 13 is the rotation device for the process substrate 18 and/or the monitor substrate 17 is located in a fixed position with the planetary 13. This process using an electron gun requires a vacuum environment within a vacuum chamber 20.

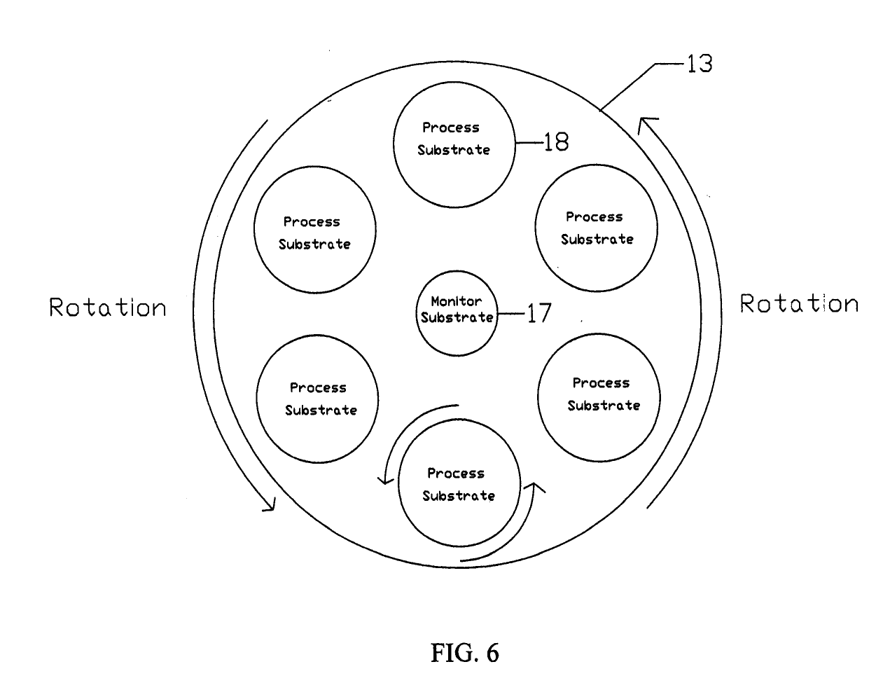

FIG. 6 depicts an example of a rotating planetary 13. The process substrates rotate around the fixed monitor substrate 17. The process substrates 18 also orbit around the center. The process substrates 18 can also be in a fixed position without rotation while rotating around the center.

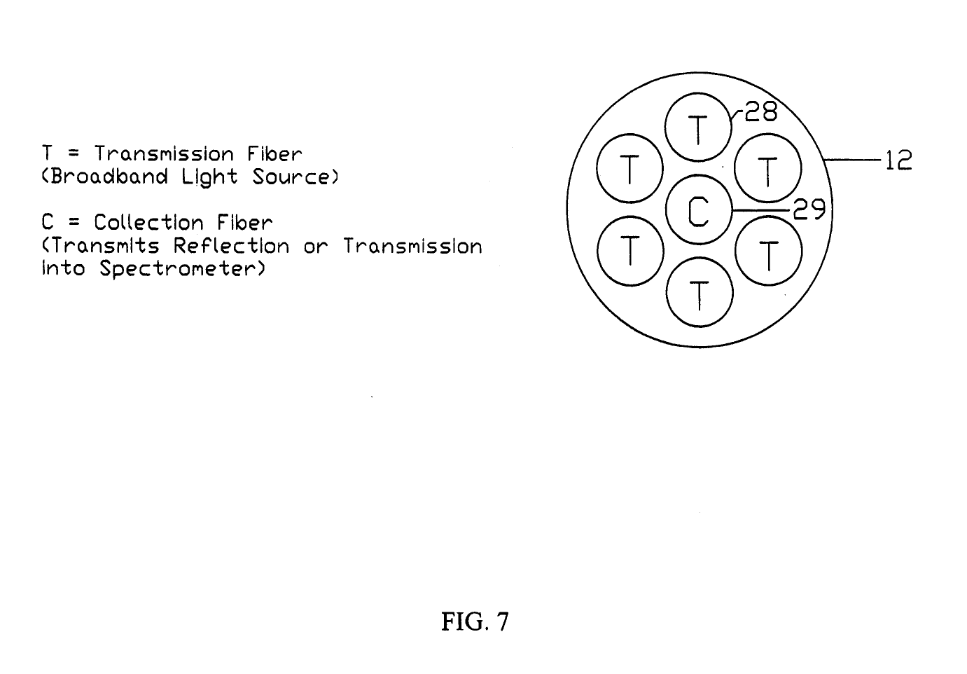

FIG. 7 depicts an example of the actual discovery. The fiber optic transmission and collection probe 12 is comprised of transmission fibers 28 and collection fibers 29. The number of each is process dependent. The fiber optic transmission and collection probe 12 is constructed to work in a vacuum environment with the possibilities of addition heat.

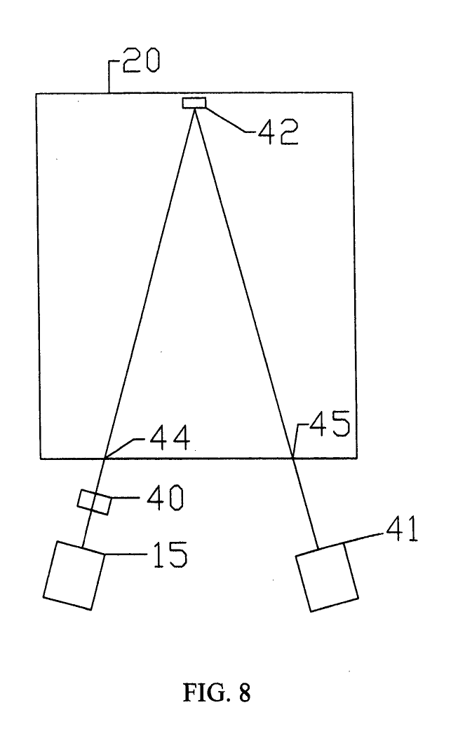

FIG. 8 depicts an example of a standard optical monitor. This system has a broadband light source 15 is converted into a monochromatic system by the use of a monochromatic filter 40. The light enters the vacuum chamber 20 through a window 44. It then reflects or transmits from the monitor chip 42 and exits through another window 45. This system allows for one wavelength of light to measure process. The monitor chip 42 must also be rotated after six or more layers. The current invention does not have the need for changing the point of measurement. It is possible to have addition systems combined, but is limited to only a few. The current discovery of the invention allows for the possibility of hundreds to over one thousand wavelengths to be measured instantaneously.

The advantage of using the spectrometer in this application is the performance of the spectrometer and the accuracy of the coatings. The spectrometer allows for multiple instantaneous wavelengths of light to be measured. Measuring multiple waves adds to the accuracy of the coating and allows the operator to see the results from each layer. Monochromatic optical monitors only provide one wavelength at a time and calculating were the signal ends is not exact.

The fiber optic probe will measure the transmission and/or the reflection of the film. The fiber optic probe is the delivery mechanism to the spectrometer. All of the wavelengths enter the probe simultaneously and then spectrometer's detector outputs the data to the computer.

Thin film performance is calculated using many different parameters. Thin film software packages account for materials deposited, index of refraction of the substrate, deposition rate, index of refraction of the incident medium, and other variables. The software can calculate spectral responses.

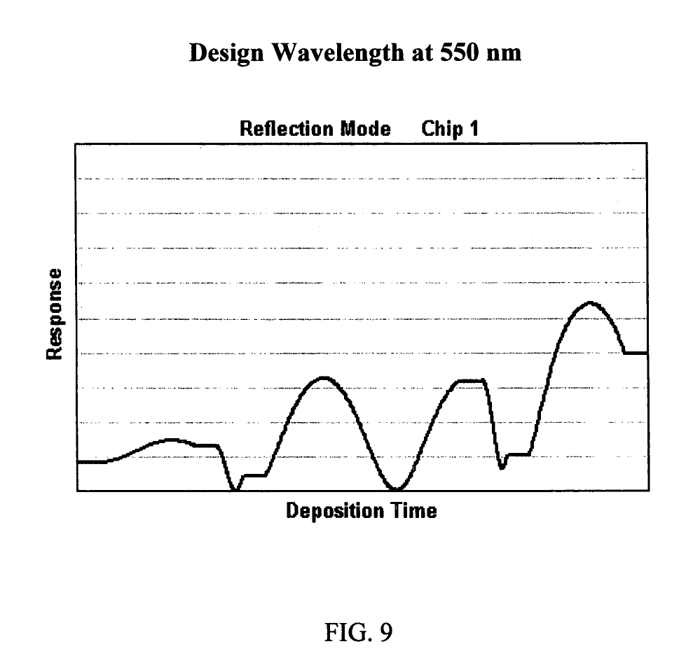

FIG. 9 is an example of a common five layer design H L 2H L H using material of a high and a low index of refraction designed for a monochromatic optical monitor. The Y axis represents percent reflection and the x axis represents deposition time. Inaccuracies and inconsistencies at the points between layers can cause the final design measurements to be out of specifications.

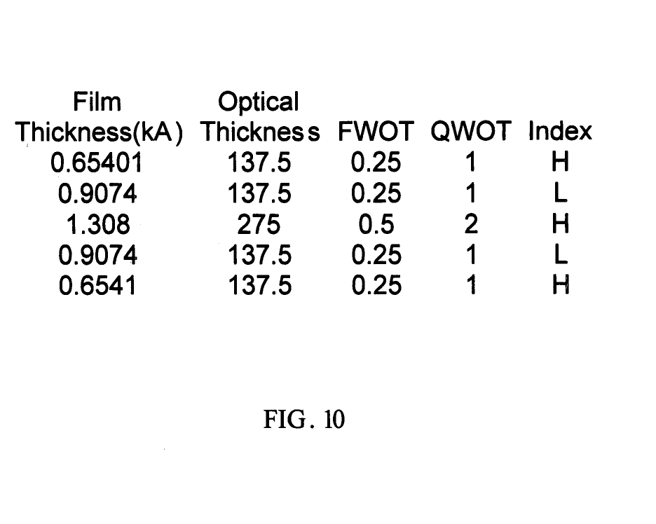

FIG. 10 is an example of a 5 layer design using material of a high and a low index of refraction. ‘H’ will represent the high index of refraction material and ‘L’ will represent the low index of refraction material. The five layer design will be represented as H L 2H L H.

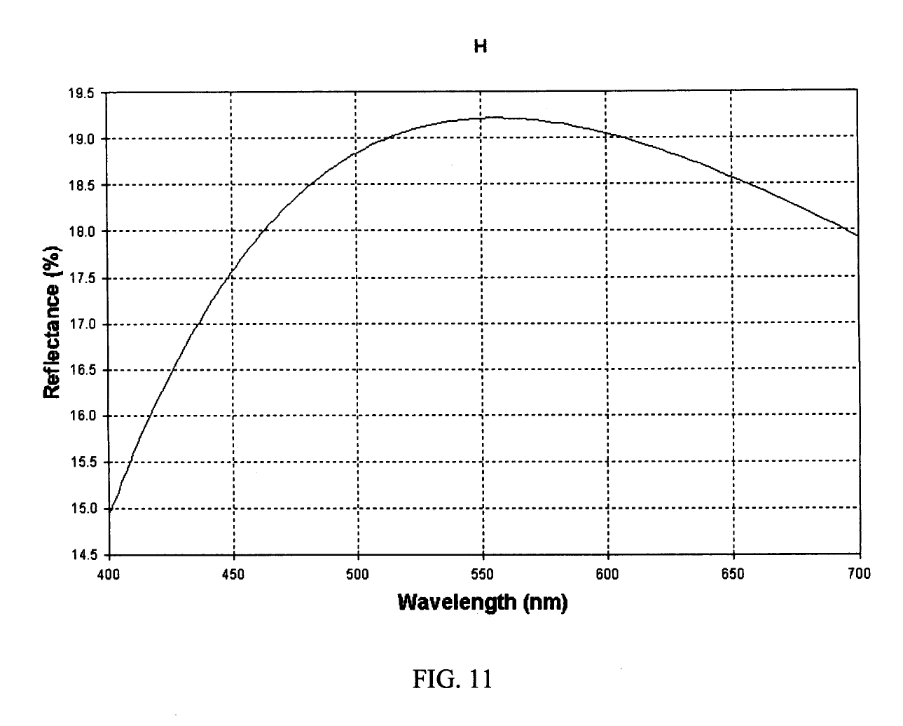

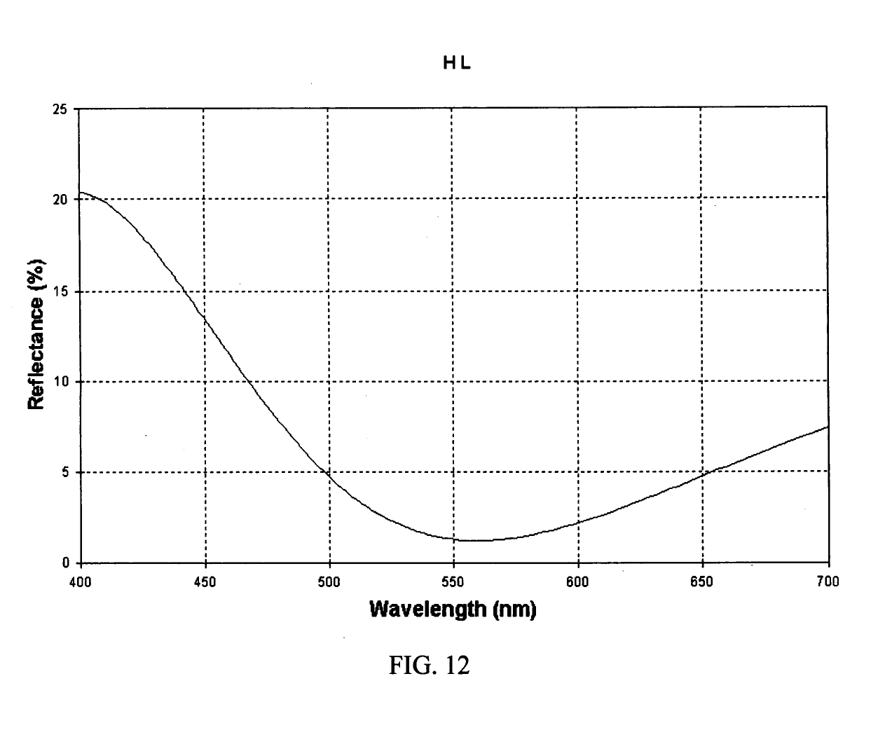

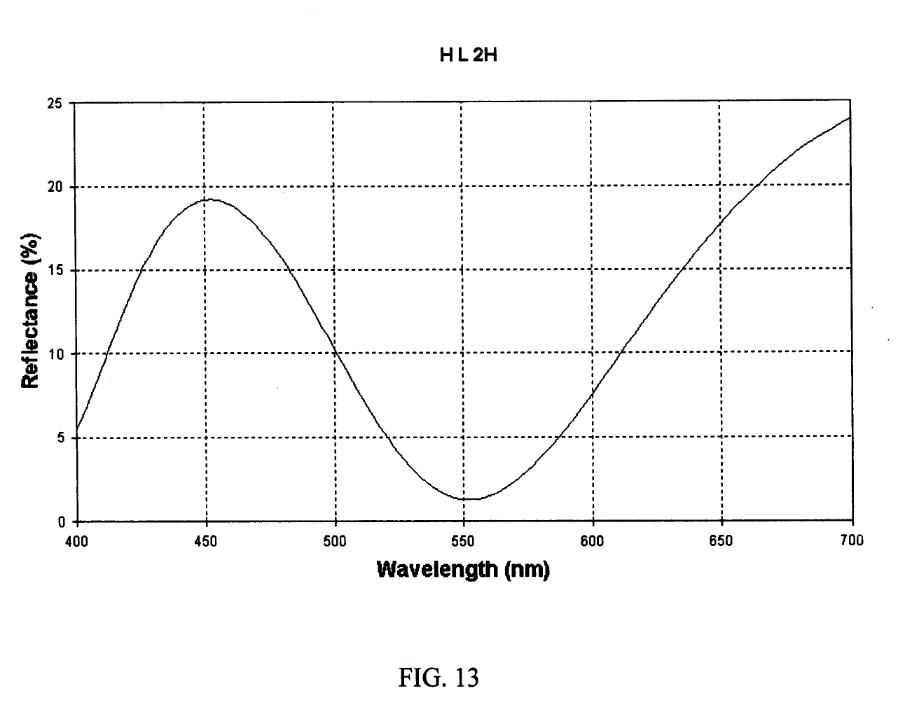

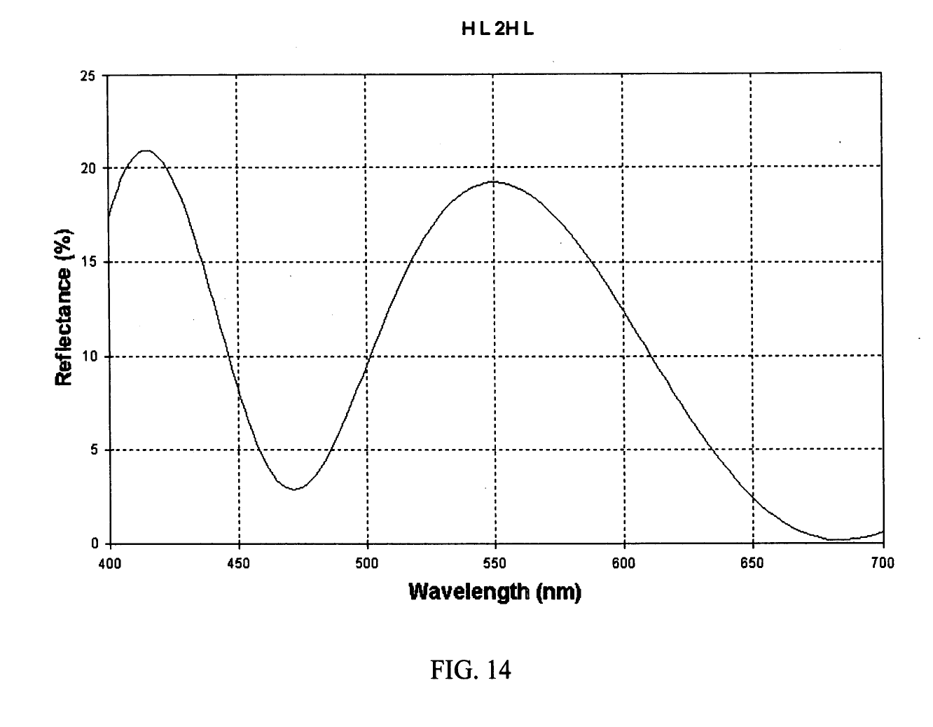

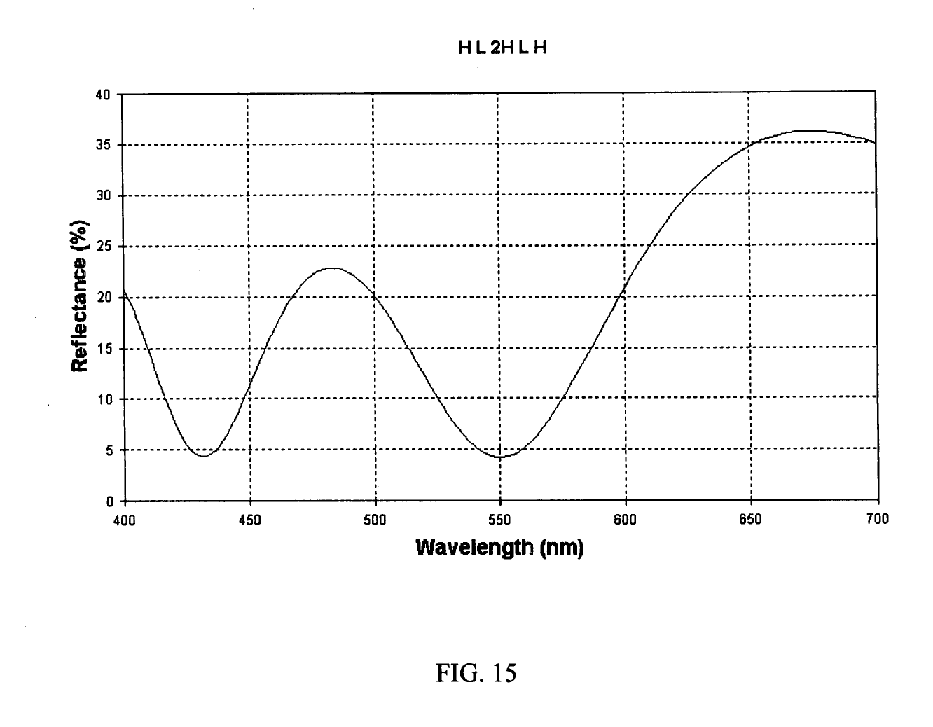

The scanning range is design and operator dependant. We have illustrated a scanning wavelength range from 400-700 nm. This means that the spectrometer is measuring over 300 wavelength responses per scan. FIG. 11 shows the spectral response of the first layer of the design. The spectrometer will continuously and instantaneously measure the thickness of the layer. In this case, the reflection data changes as the film growth changes. As the film grows in optical thickness, the response from the spectrometer (spectral scan) will start to resemble the scan in FIG. 11. The deposition of the first layer is complete once the scan is within an accepted range of fitting the theoretical curve. Layer 2 will start and follow the same procedure of layer 1. The spectrometer will scan the process monitor/process substrate. Once again, the layer will be complete once the scan is within an accepted range of fitting the theoretical curve. Layer 2 is illustrated in FIG. 12. Layer 3 is illustrated in FIG. 13. Layer 4 is illustrated in FIG. 14. Layer 5 is illustrated in FIG. 15.

The spectrometer can now scan the actual performance spectra of the part when the process is complete while it is still in the vacuum chamber. If there coating did not perform as expected, then the spectral scan can be reversed engineered to meet specifications. This can be done while the part is still under vacuum and at process temperature. Currently, parts have to cool down and the chambers are vented to atmosphere before parts could be scanned outside the chamber for spectral performance.

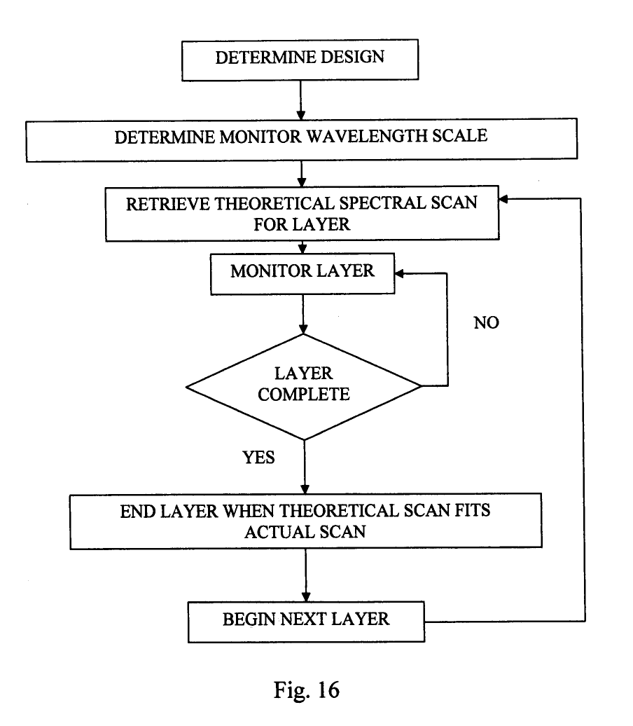

FIG. 16 is a flow chart diagram of the sequential process flow of the present invention relating to the layer measurement during and after completion of each film layer.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A method of measuring thin film thicknesses on a substrate, the method comprising the use of a spectrometer or a spectrophotometer based optical monitoring system.

2. The method according to claim 1, wherein the spectrometer or spectrophotometer measures film thickness deposited on the substrate during and after a deposition process.

3. The method according to claim 2, wherein the spectrometer or spectrophotometer measures in-situ reflectance or transmission of film growth or a combination of said reflectance and transmission of film growth during the deposition process and after a final layer is complete.

4. The method according to claim 3, wherein the spectrometer or spectrophotometer makes instantaneous and/or delayed measurements of partial waves at a specific wavelength.

5. The method according to claim 3, wherein the spectrometer or spectrophotometer makes instantaneous and/or delayed measurements of multiple scanning wavelengths.

6. An optical monitoring system comprising:
one of a spectrometer or a spectrophotometer;
one of a fiber optics transmission probe, a collection probe or a combination of said transmission and collection probes;
a broadband light source; and
means for collecting and processing data related to the deposition of material on a substrate during a deposition and after a deposition process.

7. The system according to claim 6, wherein the one of the spectrometer or the spectrophotometer measures thin films applied to the substrate during the deposition process.

8. The system according to claim 6, wherein the one of the spectrometer or the spectrophotometer measures transmission of film growth on the substrate during the deposition process, or reflectance of film growth on the substrate during the deposition process, or a combination of said transmission and reflectance of film growth on the substrate during the deposition process.

9. The system according to claim 8, wherein the system is adapted to measure thin films after the deposition process is complete.

10. The system according to claim 6, wherein said system is adapted to measure in-situ data of a fixed monitor substrate, a rotational monitor substrate, a process substrate or any combination of said fixed monitor substrate, rotational monitor substrate or process substrate.

11. The system according to claim 6, wherein the system is adapted to measure single or multiple spectral bands to monitor the thickness of each material layer as it is being applied.

12. The system according to claim 11, wherein the single or multiple spectral bands measure the reflectance and/or transmission of each layer of film deposited and the total layers of deposited films.

13. The system according to claim 12, wherein the system includes means for comparing the spectral bands of the reflectance and/or transmission of each layer of film deposited to the theoretical spectral designs over the measured region.

14. A spectrometer or spectrophotometer single or multiple spectral scanning band based thin film optical monitoring system comprising:
a fiber optic probe constructed for a vacuum environment that includes multiple fibers that transmit and collect optical properties of a fixed position monitor substrate, a process substrate or a combination of said fixed position monitor substrate and said process substrate, which is adapted for thin film monitors and measuring;
processing means for collecting and analyzing said optical properties related to a deposition process;
said processing means including means for measuring an instantaneous single wavelength transmission, a reflection or a combination of said transmission and reflection of a fixed position monitor substrate or process substrate; and
said processing means including means for measuring a single wavelength transmission, a reflection or a combination of said transmission and reflection measurement of an actual fixed position monitor substrate or process substrate,
wherein the process substrate is an actual production part being coated,
wherein the system is adapted to measure in-situ reflection or transmission or a combination of said reflection and transmission of film growth during the deposition process, and
wherein the system is adapted to measure in-situ reflection or transmission or a combination of said in-situ reflection and transmission measurements during film growth.

15. The system according to claim 14, wherein said processing means including means for measuring multiple wavelength transmission, reflection or a combination of said transmission and reflection measurements of the process substrate.

16. The system according to claim 14, wherein said processing means including means for measuring multiple wavelength transmission, reflection or a combination of said transmission and reflection measurements of the process substrate instantaneously.

17. The system according to claim 14, wherein the system is adapted to measure said in-situ reflection or transmission or combination of said reflection and transmission of film growth during the deposition process instantaneously.

18. The system according to claim 14, wherein the system is adapted to measure a deposition controlled film growth that compares a theoretical layer design to a measured layer thickness at the fixed position monitor substrate.

19. The system according to claim 14, wherein the system is adapted to measure a deposition controlled film growth that compares a theoretical layer design to a measured layer thickness at the process substrate.
